(19) United States
(12) Patent Application Publication
(10) Pub. No.: US 2019/0111995 A1
(43) Pub. Date: Apr. 18, 2019

(54) Reciprocating Action Drive with Uni-directional Output

(71) Applicant: Roy Rosser, Monmouth Junction, NJ (US)

(72) Inventor: Roy Rosser, Monmouth Junction, NJ (US)

(21) Appl. No.: 15/785,758

(22) Filed: Oct. 17, 2017

Related U.S. Application Data
(60) Provisional application No. 62/572,502, filed on Oct. 15, 2017.

(51) Int. Cl. B62M 1/28; F16D 41/069; B62M 1/30; F16H 31/00

(52) U.S. Cl. CPC B62M 1/28; F16H 31/001; B62M 1/30; F16D 41/069

(57) ABSTRACT

A reciprocating action drive for converting reciprocating linear motion to uni-directional rotational motion is disclosed. The reciprocating action drive has a lever arm connected to a drive shaft via a first overrunning clutch such that when the lever arm is rotated in a first direction of rotation by a reciprocating linear motion, the drive shaft is rotates in the same direction. A further overrunning clutch connects the drive shaft such that the drive shaft may rotate in the first direction with respect to the frame, but not in the second, opposite direction. Such an arrangement prevents the drive shaft being driven in the second opposite, direction with respect to the frame. This prevents the lever arms being driven to interfere with any connection they may have to a source of linear reciprocating motion, thereby avoiding damage to such a connection.

### CROSS-REFERENCE TO RELATED APPLICATIONS

This application is related to co-pending U.S. patent application Ser. No. 15/607,576 entitled “Reciprocating Action Drive”, filed on May 29, 2017, the contents of which are hereby incorporated by reference in their entirety.

This application claims priority to U.S. Ser. No. 62/572,502 entitled “Magnetically Pivoting Overrunning Clutch and Application Thereof”, filed on Oct. 15, 2017, the contents of which are fully incorporated herein by reference.

### BACKGROUND OF THE INVENTION

### (1) Field of the Invention

The invention relates to a mechanical device for converting reciprocating linear motion to uni-directional rotary motion, and more particularly, to the use of multiple overrunning clutches to perform that conversion such that the drive shaft is not only driven in one direction, but is also prevented from rotating in an opposite direction.

### (2) Description of the Related Art

The technical problem of converting reciprocating linear motion to rotary motion is inherent in the technical field of mechanical drive chains.

This conversion may, for instance, be performed using a crank. However, if the input motion is close to liner, a crank's efficiency in making the motion conversion may vary with crank angle, and typically the effective conversion of linear to rotary motion is approximately proportional to the sine of the crank angle. This means that it is zero at zero crank angle, sometimes referred to as “top dead center”, and only becomes reasonably effective when the crank angle is in a range of about 30 to 120 degrees, becoming zero again at 180 degrees of crank angle.

To overcome this defect of a crank, a lever arm may be connected to the drive shaft via an overrunning clutch to effect the conversion of reciprocating liner motion to uni-directional rotary motion, as described in detail in co-pending U.S. patent application Ser. No. 15/607,576 filed on May 29, 2017, the contents of which are hereby incorporated by reference in their entirety.

Such an arrangement allows the conversion to always be in the 30 to 120-degree effective transfer angle of the lever arm. However, this arrangement may be problematic if the drive shaft is accidently, or intentionally, driven in a counter direction.

For instance, the lever arm may be connected to the drive shaft by an overrunning clutch that allows the drive shaft to move in a first direction of rotary motion. In such an arrangement, the range of motion of the lever arm may be constrained by a connection between the lever arm and a source of linear, reciprocating motion. The source of linear, reciprocating motion may, for instance, move the drive shaft in an arc from, for instance, 30-degrees to 120-degrees. If, for some reason, a force is applied to the drive shaft to turn it in an opposite direction to which it is normally turned, the lever arm may be driven outside of that desired range of motion, and in doing so, may compromise the link between the lever arm and the source of linear, reciprocating motion.

A means of limiting the forced motion of the lever arms in a wrong direction outside of their intended motion may therefore be desired in order to avoid compromising any mechanical linkage between the lever arms and the source of linear, reciprocating motion.

The relevant prior art includes:

U.S. Pat. No. 584,200 issued to J. Wheatley on Jun. 8, 1897 entitled “Bicycle” that describes a sprocket-wheel mounted to rock or oscillate on a stud carried by the bicycle frame, a sprocket-chain engaging said sprocket-wheel, fulcrumed pedal-levers to which the lower ends of the chain are attached, a curved rack on the sprocket-wheel, a shaft mounted to rotate on the bicycle-frame and arranged at right angles to the axis of said sprocket-wheel, bevel-gears loosely mounted on said shaft and meshing with the curved rack, clutch devices between the shaft and gear-wheels, a sprocket-wheel rigidly secured on one end of the said shaft, and a sprocket-chain connecting said sprocket-wheel with a sprocket-wheel on the axle of the rear wheel of the bicycle.

U.S. Pat. No. 8,702,115 issued to Kramer, et al. on Apr. 22, 2014 entitled “Drive mechanism and bicycle drive system” that describes a drive mechanism (that) effects a rotary power output in response to a reciprocating power input resulting from substantially linear forces applied to the drive mechanism, such as those forces applied by a rider on a bicycle. The drive mechanism includes input bevel gears meshed with corresponding output bevel gears coupled to a common power output shaft through clutches that effect a rotary power output at the power output shaft in response to the reciprocating power input from the substantially linear forces. Opposite crank arms are coupled with the input bevel gears such that each crank arm is advanced by an applied substantially linear force, and is retracted upon advancement of the opposite crank arm. In a bicycle, opposite pedals are coupled to corresponding crank arms and are moved through predetermined power strokes in response to substantially linear forces applied by a rider to effect corresponding rotational movements of the input bevel gears and concomitant rotary power output at the power output shaft.

UK Patent Application GB 2 219 261 entitled “Reciprocating Human Drive Mechanism” filed on May 3, 1989 by inventor Alan David Ferrie that describes a bicycle drive unit consisting of a pair of angularly reciprocable pedal levers 2,3 connected to drive a hollow cylindrical casing 4 through respective pawl-and-ratchet one-way clutches 10, 11, the cycle rear wheel being chain-driven from a main sprocket wheel 5 carried by the casing 4. A motion reversing mechanism interconnects the pedals 2, 3, consisting of bevel gears 8, 9 and reversing pinions 7. The drive unit is arranged on a common cross-shaft 2 fixed to the cycle frame. The arrangement permits the drive wheel of the bicycle to be given more useful pedal effort per unit of time than a conventional crank arrangement.

U.S. Pat. No. 5,390,773 issued to Proia on Feb. 21, 1995 entitled “Non-slip bicycle clutch” that describes a clutch mechanism for use on a conventional bicycle which permits independent actuation of both pedals and provides a driving force through 100% of a pedal stroke. The clutch is generally comprised of a single, outer, cylindrical rotor which extends between the two pedals, and two internal rotors, respective to each pedal, positioned within the outer rotor. The internal rotors each include respective longitudinally extending, annularly spaced webs and longitudinally extending V-shaped portions integrally positioned between successive webs. In addition, magnets are attached to each rotor and positioned at the vortices of the V-shaped portions. The clutch further includes a set of cylindrical rods positioned between the two rotors which become wedgingly engaged between the magnets and the outer rotor when the pedal is actuated by a user of the bike. In addition, each pedal is attached to the frame of the bike via a spring which prohibits the pedal from being rotated a full 360-degree. After the pedal has been extended through a predetermined stroke, the resiliency of the spring causes the return of the pedal to its original position. This, in essence provides for 100% of the user's energy to be converted into useful work.

Various implementations are known in the art, but fail to address all of the problems solved by the invention described herein. Various embodiments of this invention are illustrated in the accompanying drawings and will be described in more detail herein below.

### BRIEF SUMMARY OF THE INVENTION

An inventive reciprocating action drive for converting reciprocating linear motion to uni-directional rotational motion is disclosed.

In a preferred embodiment, the reciprocating action drive may include a first lever arm connected to a drive shaft via a first overrunning clutch so that when the first lever arm is rotated in a first direction of rotation by the action of the reciprocating linear motion, the drive shaft is also moved to rotate in the first direction of rotation. When the first lever arm is, however, caused to rotate in a second, opposite direction of rotation, the first overrunning clutch freewheels, and the lever arm may not affect the rotation of the drive shaft.

A further overrunning clutch that may connect the drive shaft to a frame is preferably also included. The frame may, for instance, be the frame of a vehicle being propelled by the drive shaft. The further overrunning clutch may allow the drive shaft to rotate in the first direction with respect to the frame, but not in the second, opposite direction.

Such an arrangement may, for instance, prevent the drive shaft being driven in a second, opposite, direction with respect to the frame. Preventing the drive shaft from being moved in this second, opposite direction may also prevent the lever arms from being forcibly moved in the second, opposite direction. Such movement may, if the lever arms are driven far enough, interfere with, or compromise, any connection they may have to a source of linear reciprocating motion, possibly resulting in damage to such a connection. This additional overrunning clutch may, therefore, provide protection against accidental, or intentional, damage in such a reciprocating action drive.

In a further preferred embodiment of the invention, the reciprocating action drive may also include a second lever arm connected to the drive shaft via a second overrunning clutch such that when the second lever arm is moved by a source of linear, reciprocating motion to rotate in the first direction of rotation, the drive shaft is also rotated in the first direction of rotational motion.

There may also be a direction reversing mechanism that may functionally attach the first lever arm to the second lever arm such when the first lever arm is moved in the first direction of rotation, the second lever arm is moved in the second, opposite direction of rotation.

This direction reversing function may, for instance, be accomplished using mechanisms such as, but not limited to, beveled gears connecting the first and second overrunning clutches, or a flexible cable that may pass over a restraining channel attached to the frame, and connect the two lever arms in such a way that when the first lever arm is moved in a first direction of rotation, the second lever arm is moved in a second, opposite direction of rotation, and vice versa, or some combination thereof.

In a further a further preferred embodiment of the present invention, one or more of the overrunning clutches may be a magnetically sprung overrunning clutch. Such a magnetically sprung overrunning clutch may, for instance, be include one or more pivoting sprags located between the drive shaft and either the frame or one of said lever arms, and the pivoting sprags may each include at least one sprag magnet, that may, for instance, be a rare-earth, permanent magnet.

Therefore, the present invention succeeds in conferring the following, and others not mentioned, desirable and useful benefits and objectives.

It is an object of the present invention to provide a reciprocating action drive in which there is protection against the drive shaft being turned in a wrong direction and so possibly damaging a connection between a lever arm and a mechanism providing linear reciprocation motion to them.

### BRIEF DESCRIPTION OF THE SEVERAL VIEWS OF THE DRAWINGS

FIG. 1 shows a schematic, isometric view of a single lever, reciprocating action drive with uni-directional output of one embodiment of the present invention.

FIG. 2 shows a schematic, isometric view of a double lever, reciprocating action drive with uni-directional output of one embodiment of the present invention.

FIG. 3A shows a schematic, side view of a double lever, reciprocating action drive with uni-directional output of one embodiment of the present invention.

FIG. 3B shows a schematic, plan view of a double lever, reciprocating action drive with uni-directional output of one embodiment of the present invention.

FIG. 4 shows a schematic, plan view of a reciprocating action drive with a beveled gear reversing mechanism of one embodiment of the present invention.

FIG. 5 shows a schematic side view of a bicycle fitted with a reciprocating action drive having a flexible cable reversing mechanism of one embodiment of the present invention.

FIG. 6 shows a schematic close up view of a reciprocating action drive having a flexible cable reversing mechanism of one embodiment of the present invention.

FIG. 7 shows a schematic X-sectional view of a magnetically sprung overrunning clutch of one embodiment of the present invention.

### DETAILED DESCRIPTION OF THE INVENTION

The preferred embodiments of the present invention will now be described in more detail with reference to the drawings in which identical elements in the various figures are, as far as possible, identified with the same reference numerals. These embodiments are provided by way of explanation of the present invention, which is not, however, intended to be limited thereto. Those of ordinary skill in the art may appreciate upon reading the present specification and viewing the present drawings that various modifications and variations may be made thereto without departing from the spirit of the invention.

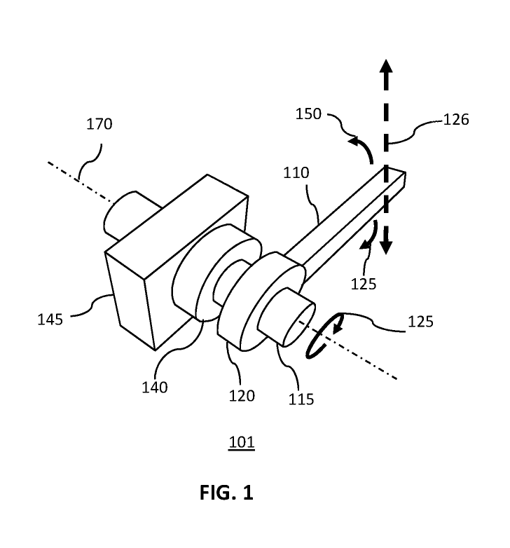

FIG. 1 shows a schematic, isometric view of a single lever, reciprocating action drive, with uni-directional output, of one embodiment of the present invention.

The single lever, reciprocating action drive, with uni-directional output 101, shown in FIG. 1 includes a first lever arm 110 attached to a drive shaft 115 via a first overrunning clutch 120. This arrangement may allow the first lever arm 110, when driven in a first direction of rotation 125, by a source of linear, reciprocating motion 126, to cause the drive shaft 115 to rotate in a first direction of rotation 125. When the first lever arm 110 is, however, moved in a second, opposite direction of rotation 150, the first overrunning clutch 120 may allow the first lever arm 110 to free-wheel with respect to the drive shaft 115. This arrangement may, therefore, enable the linear reciprocating motion provided by a source of linear, reciprocating motion 126, to be converted into uni-directional rotary motion.

A further overrunning clutch 140 may connect the drive shaft 115 to a frame 145 such that the drive shaft may rotate in the first direction of rotation 125 with respect to the frame 145, but not in a second, opposite direction of rotation 150. This may, for instance, provide protection against damage that may be caused to any linkage between the source of linear, reciprocating motion 126, and the reciprocating action drive. if the first lever arm 110 is driven by the drive shaft 115 in the second, opposite direction of rotation 150 to a point at which any such linkage may be compromised.

In the arrangement shown in FIG. 1, the motion of the first lever arm 110 in the second, opposite direction of rotation 150, i.e., when the lever arm is free-wheeling with respect to the drive shaft, may be driven by the source of linear, reciprocating motion 126, or it may also, or instead, be provided by a spring element that may be suitably situated between the frame 145 and the first lever arm 110.

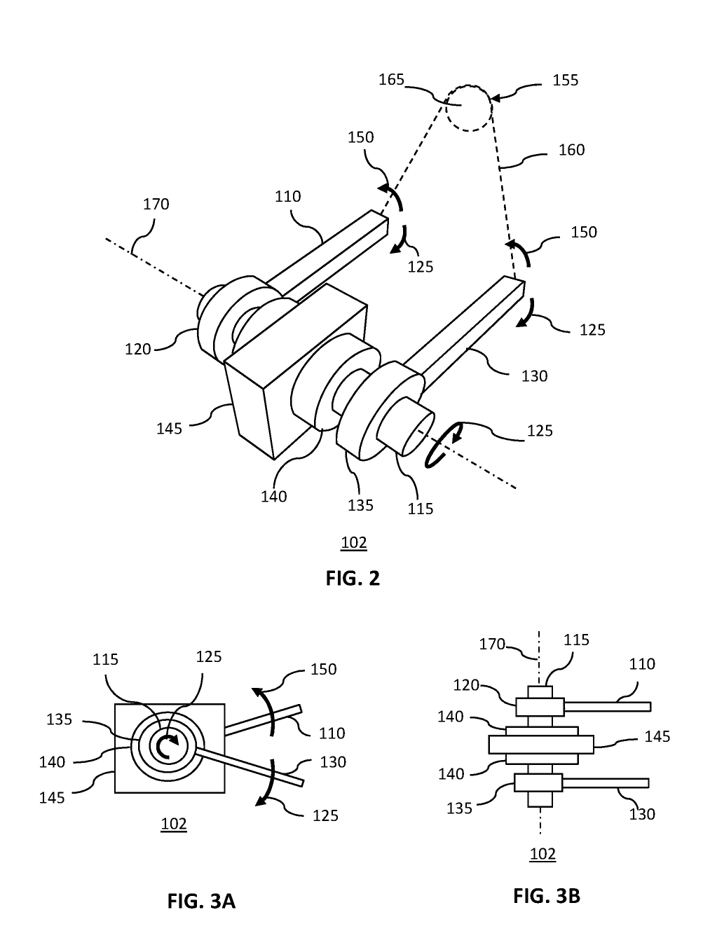

FIG. 2 shows a schematic, isometric view of a double lever, reciprocating action drive with uni-directional output 102 of one embodiment of the present invention.

As shown in FIG. 2, the double lever, reciprocating action drive with uni-directional output 102 includes both a first lever arm 110 and a second lever arm 130. These may be connected to the drive shaft 115 by, respectively, a first overrunning clutch 120 and a second overrunning clutch 135. Each of these overrunning clutches may allow their respective lever arms, when driven inn a first direction of rotation 125 by a source of linear, reciprocating motion, to impart movement to the drive shaft 115 in the first direction of rotation 125. However, the overrunning clutches may overrun, or free-wheel, when the levers are moved to rotate in a second, opposite direction of rotation 150. In this way, a reciprocating, linear, or near linear, motion may be converted to uni-directional rotary motion about an axis of rotation 170.

In some embodiments of a double lever, reciprocating action drive with uni-directional output, it may be desirable that the lever arms are retained within a certain range of motion. This limit on the lever arms range of motion may, for instance, be occasioned by mechanical linkages to a source of linear, reciprocating motion. Or it may be due to limit stops placed to constrain the lever arm range of motion. In order to prevent the drive shaft 115 being accidently, or deliberately, driven in the wrong direction, i.e., the second, opposite direction of rotation 150, a third overrunning clutch 140 may be used. The third overrunning clutch 140 may link the drive shaft 115 to a frame 145 such that the drive shaft 115 may rotate in the first direction of rotation 125 but not in the second, opposite direction of rotation 150. This may prevent the drive shaft 115 being used to drive the lever arms out of their desired range of motion.

As shown in FIG. 2, the lever arms may be functionally linked by a direction reversing mechanism 155. This may be useful when the source of linear, reciprocating motion only provides a driving force in one direction. The direction reversing mechanism 155 may then allow part of the force being used to drive the first lever arm 110 in a first direction of rotation 125 to simultaneously drive the second lever arm 130 in a second, opposite direction of rotation 150, and so place it in position to be powered on the next power stroke of the source of linear, reciprocating motion. The uni-direction powered source of linear, reciprocating motion may, for instance, be propulsion mechanisms such as, but not limited to, a cyclist's legs, or the pistons of an internal combustion engine.

In FIG. 2, an exemplary direction reversing mechanism 155 is shown that is a flexible cable 160 running over a restraining channel 165 that may be attached to the frame 145. One of ordinary skill in the art will, however, appreciate there are many other forms the direction reversing mechanism 155 may take such as, but not limited to, a beveled gear reversing mechanism.

FIG. 3A shows a schematic, side view of a double lever, reciprocating action drive with uni-directional output 102 of one embodiment of the present invention.

The double lever, reciprocating action drive with uni-directional output 102 shown in FIG. 3A includes a first lever arm 110 and a second lever arm 130. The first lever arm 110 may be attached to the drive shaft 115 via a first overrunning clutch (not visible in FIG. 3A), while the second lever arm 130 may be attached to the drive shaft 115 via a second overrunning clutch 135. Both overrunning clutches may be connected such that when the lever arms are moved to rotate in a first direction of rotation 125, the drive shaft 115 may also be moved to rotate in the first direction of rotation 125. However, when the levers are moved in the second, opposite direction of rotation 150, the overrunning clutches allow them to free-wheel with respect to the drive shaft 115.

The drive shaft 115 may also be attached to a frame 145 via a third overrunning clutch 140. The third overrunning clutch 140 may be arranged so that the drive shaft 115 may free-wheel when rotated in the first direction of rotation 125 with respect to the frame 145, but to lockup if the drive shaft 115 is attempted to be rotated in the second, opposite direction of rotation 150 with respect to the frame 145. In this manner, the lever arms may be protected from being accidently, or deliberately, driven in the second, opposite direction of rotation 150 with respect to the frame 145.

FIG. 3B shows a schematic, plan view of a double lever, reciprocating action drive with uni-directional output of one embodiment of the present invention.

The double lever, reciprocating action drive with uni-directional output 102 shown in the plan view of FIG. 3B includes a first lever arm 110 connected via a first overrunning clutch 120 to a drive shaft 115, and a second lever arm 130 connected via a second overrunning clutch 135 to the drive shaft 115. The drive shaft 115 may also be connected to a frame 145 via one or more third overrunning clutches 140. All the overrunning clutches and the drive shaft 115 rotate about an axis of rotation 170.

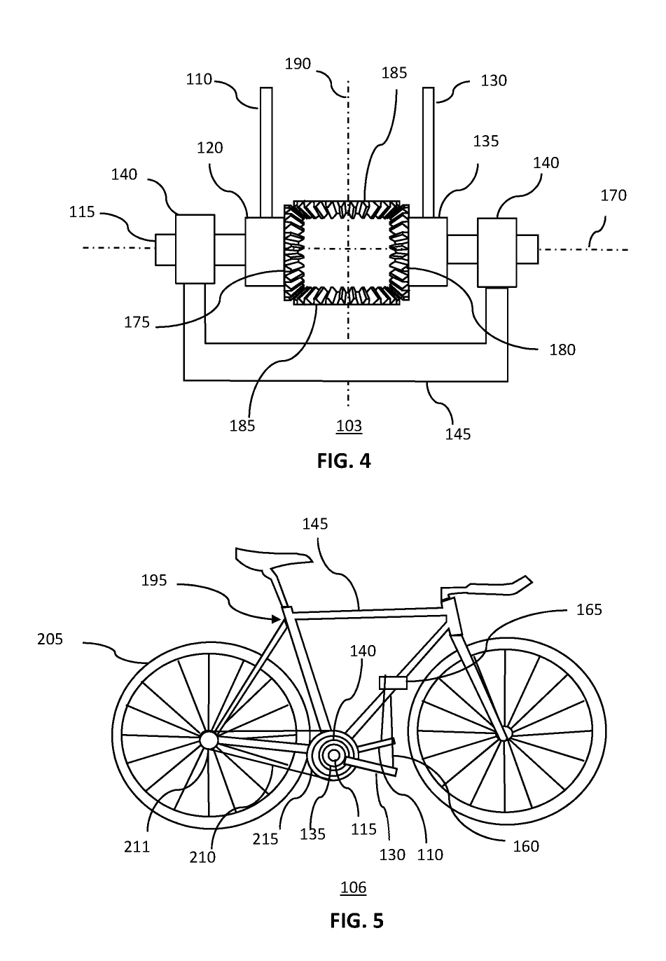

FIG. 4 shows a schematic, plan view of a reciprocating action drive with a beveled gear reversing mechanism 103 of one embodiment of the present invention.

The reciprocating action drive with a beveled gear reversing mechanism 103 may include a first lever arm 110 that may be connected to a drive shaft 115 via a first overrunning clutch 120. An outer shell of the first overrunning clutch 120 may also be directly connected to a first beveled gear 175. There may also be a second lever arm 130 connected to the drive shaft 115 via a second overrunning clutch 135. The outer shell of the second overrunning clutch 135 may be directly connected to a second beveled gear 180.

The first beveled gear 175 and the second beveled gear 180 may be functionally connected via one or more third bevel gears 185. The first and second bevel gears may rotate around the same axis of rotation 170 as the drive shaft 115. The third bevel gears 185 may rotate about a second axis of rotation 190, that may be orthogonal to the drive shaft axis of rotation. The combination of beveled gears may thus provide a direction reversing mechanism in which moving the first lever arm 110 in one rotational direction causes the second lever arm 130 to rotate in a second, opposite direction of rotation, and vice versa.

The drive shaft 115 may also be connected to a frame 145 via one or more third overrunning clutch 140. The third overrunning clutch 140 may be arranged such that the drive shaft 115 may free-wheel with respect to the frame 145 in the rotational direction in which the lever arms may provide power to the drive shaft.

FIG. 5 shows a schematic side view of a bicycle 195 fitted with a reciprocating action drive having a flexible cable reversing mechanism 106 of one embodiment of the present invention.

The bicycle 195 may include a frame 145 and two wheels, free to rotate in either direction with respect to the bicycle frame. The bicycle 195 may be propelled via a drive shaft 115 that may be directly connected to a chain ring 215 that may in turn drive the bicycle rear tire 205 via a drive chain 210. The drive chain 210 may engage a sprocket wheel 211 on a rear hub that may be directly connected to a rear wheel supporting a bicycle rear tire 205.

The drive shaft 115 may be driven by a first lever arm 110 and a second lever arm 130 that may be connected to the drive shaft 115 by, respectively, a first overrunning clutch 120 (not shown in FIG. 5) and a second overrunning clutch 135. The drive shaft 115 may also be connected to the bicycle frame 145 via a third overrunning clutch 140.

The first and second lever arms may be connected by a flexible cable 160 that may pass over a restraining channel 165 that may be connected to the frame 145, thereby forming a direction reversing mechanism.

The flexible cable 160 may be any suitable cable such as, but not limited to, a stainless steel lanyard, or a suitably sized cable, rope or tape, that may be made of a material or fibers, such as, but not limited to, stainless steel, steel, aluminum, Nylon™, Kevlar™, polyester, polypropylene, poly-aramid, cotton, leather, wool, or silk, or some combination thereof.

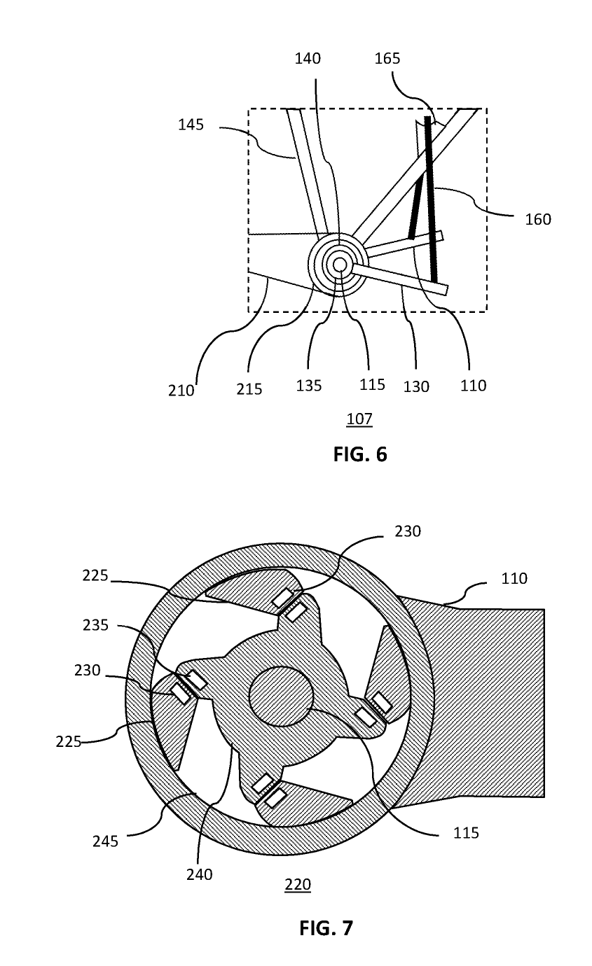

FIG. 6 shows a schematic close up view of a reciprocating action drive having a flexible cable reversing mechanism 107 of one embodiment of the present invention.

Shown in FIG. 6 are a first lever arm 110 and a second lever arm 130 linked by a flexible cable 160 that runs over a restraining channel 165 attached to the frame 145, that may, for instance, be a bicycle frame. This arrangement may form a direction reversing mechanism that, when the first lever arm 110 is driven in one direction, the second lever arm 130 may be driven in an opposite direction, and vice versa.

The first lever arm 110 is shown connected to the drive shaft 115 via a second overrunning clutch 135. The drive shaft 115 may also be connected directly to a chain ring 215, and via a third overrunning clutch 140 to the frame 145. The chain ring 215 may be connected to a drive chain 210 that may be used to power a bicycle via a rear wheel.

The flexible cable 160 may be made of any suitable material or fibers, such as, but not limited to, stainless steel, steel, aluminum, Nylon™, Kevlar™, polyester, polypropylene, poly-aramid, cotton, leather, wool, or silk, or some combination thereof.

The restraining channel 165 may simply rely on having a low friction surface such as, but not limited to, a nylon, Teflon™, steel, aluminum or stainless steel, or some combination thereof, or it may include bearing such as, but not limited to, roller bearings made of a suitable material such as, but not limited to, nylon, aluminum, steel or stainless steel, or some combination thereof.

The restraining channel 165 may be a part of the frame 145 or it may be rigidly attached to the frame 145 by some suitable mechanism such as, but not limited to, welding, gluing or bolting, or some combination thereof.

FIG. 7 shows a schematic X-sectional view of a magnetically sprung overrunning clutch of one embodiment of the present invention.

The magnetically sprung overrunning clutch 220 may include one or more pivoting sprags 225 each of which may include one or more sprag permanent magnet 230. The pivoting sprags 225 may be situated between an inner surface 245 of a magnetically sprung overrunning clutch outer shell and a anchor magnet holding element 240. The magnetically sprung overrunning clutch outer shell may be directly connected to, or be a part of a first lever arm 110. The anchor magnet holding element 240 may be directly connected to, or be a part of the drive shaft 115. In that way, the pivoting sprags 225 may be functionally situated between the first lever arm 110 and the drive shaft 115.

The sprag permanent magnet 230 may be attracted to a ferromagnetic material attached to the drive shaft or to the anchor magnet holding element 240. The ferromagnetic material may, for instance, be an anchor magnet 235. The sprag permanent magnet 230 and the anchor magnets 235 may either, or both, be permanent magnets such as, but not limited to, neodymium rare-earth magnets.

In an alternate embodiment, one or more of the anchor magnets 235 may be electro-magnets.

Although this invention has been described with a certain degree of particularity, it is to be understood that the present disclosure has been made only by way of illustration and that numerous changes in the details of construction and arrangement of parts may be resorted to without departing from the spirit and the scope of the invention.

The invention claimed is:

1: A reciprocating action drive, comprising:
a first lever arm connected to a drive shaft via a first overrunning clutch such that when said first lever arm is rotated in a first direction of rotation, said drive shaft also rotates in said first direction of rotational motion about a common axis of rotation; and
a further overrunning clutch connecting said drive shaft to a frame such that said drive shaft may rotate in a first direction of rotation with respect to said frame, but not in a second, opposite direction of rotation about said common axis of rotation.

2: The reciprocating action drive of claim 1, further comprising:
a second lever arm connected to said drive shaft via a second overrunning clutch such that when said second lever arm is rotated in said first direction of rotation, said drive shaft is also rotated in said first direction of rotational motion about said common axis of rotation.

3: The reciprocating action drive of claim 2, further comprising:
A direction reversing mechanism functionally attaching said first lever arm to said second lever arm such when said first lever arm is moved in said first direction of rotation, said second lever arm is moved in said second, opposite direction of rotation.

4: The reciprocating action drive of claim 3, wherein, said direction reversing mechanism comprises: a first beveled gear connected to said first lever arm; a second beveled gear connected to said second lever arm; and one or more third bevel gears functionally connecting said first beveled gear to said second beveled gear.

5: The reciprocating action drive of claim 3, wherein, said direction reversing mechanism comprises: a flexible cable connecting said first lever arm to said second lever arm, and, wherein, said flexible cable passes over a restraining channel attached to, or a part of, said frame such that when said first lever arm is moved in said first direction of rotation, said second lever arm is moved in said second, opposite direction of rotation.

6: The reciprocating action drive of claim 5, wherein, said flexible cable is a stainless steel lanyard.

7: The reciprocating action drive of claim 5, wherein, said restraining channel further comprises one or more roller bearings.

8: The reciprocating action drive of claim 1, wherein one or more of said overrunning clutches is a magnetically sprung overrunning clutch comprising one or more pivoting sprags located between said drive shaft and either said frame or one of said lever arms, and said pivoting sprags each comprise at least one sprag permanent magnet.

9: The reciprocating action drive of claim 8, wherein said sprag permanent magnet is a rare-earth, permanent magnet.

10: The reciprocating action drive of claim 8, further comprising one or more anchor magnets corresponding to said pivoting sprags, and, wherein, said anchor magnets are fixed to either said drive shaft or to one of said lever arms.

11: The reciprocating action drive of claim 10 wherein one or more of said anchor magnets is an electro-magnet.
